(19) United States
(12) Patent Application Publication
(10) Pub. No.: US 2013/0015974 A1
(43) Pub. Date: Jan. 17, 2013

(54) Debo alarm system (D.A.S.)

(71) Applicant: Durwin Keith Lasker, Conway, AR (US)

(72) Inventor: Durwin Keith Lasker, Conway, AR (US)

(21) Appl. No.: 13/506,774

(22) Filed: Jun. 22, 2012

Related U.S. Application Data
(60) Provisional application No. 61/572,227, filed on Jul. 13, 2011.

(51) Int. Cl. G08B 13/08; G08B 13/00; G08B 13/14

(52) U.S. Cl. 340/547; 340/568.1; 340/541

(57) ABSTRACT

Debo Alarm System is a mobile Security System for the Home, Apartment, RV, and Commercial Businesses etc. . . This alarm system is unique because it utilizes the existing wiring in the area you are trying to secure. The system works like a traditional alarm system. The alarm system is activated when the monitors are separated from each other. The monitors consist of one receiver and one magnet. The receiver sends a remote signal to the alarm system when the magnet is removed from it. The receiver or the magnet can be stationary or movable. The receiver and magnet are placed next to each other; one goes on the window or window frame, door or door frame. When separated the receiver sends a signal to the Debo Alarm System (D.A.S.) that the window or door is open.

### BACKGROUND OF THE INVENTION

This is base on Provisional Patent Number 61/572,227 filed on the date of Jul. 13, 2011.

### SUMMARY OF THE INVENTION

Debo Alarm System is a mobile Security System for the Home, Apartment, RV, and Commercial Businesses etc. . . This alarm system is unique because it utilizes the existing wiring in the area you are trying to secure. The reason for the Debo Alarm System is to give the everyday consumer the ability to protect their family, self and property. The Debo Alarm System allows consumers the ability to afford and possess a security device without the overhead cost of installation and monthly expense. The Debo Alarm System targets college students, single individuals and family who have a limited income resource. The system gives them the ability to protect themselves without the cost of an expensive alarm system.

### BRIEF DESCRIPTION OF DRAWINGS

FIG. 1 is a perspective view of the front, back and top of the Debo Alarm System's Keypad.

FIG. 2 is a perspective view of the front, back, side and top of the Debo Alarm System's Base that houses the keypad. The Base is installed where the central light switch is located.

FIG. 3 is a perspective view of the Debo Alarm System's Magnet and Receiver which are movable or stationary devices.

### DETAILED DESCRIPTION OF THE DEBO ALARM SYSTEM (D.A.S.)

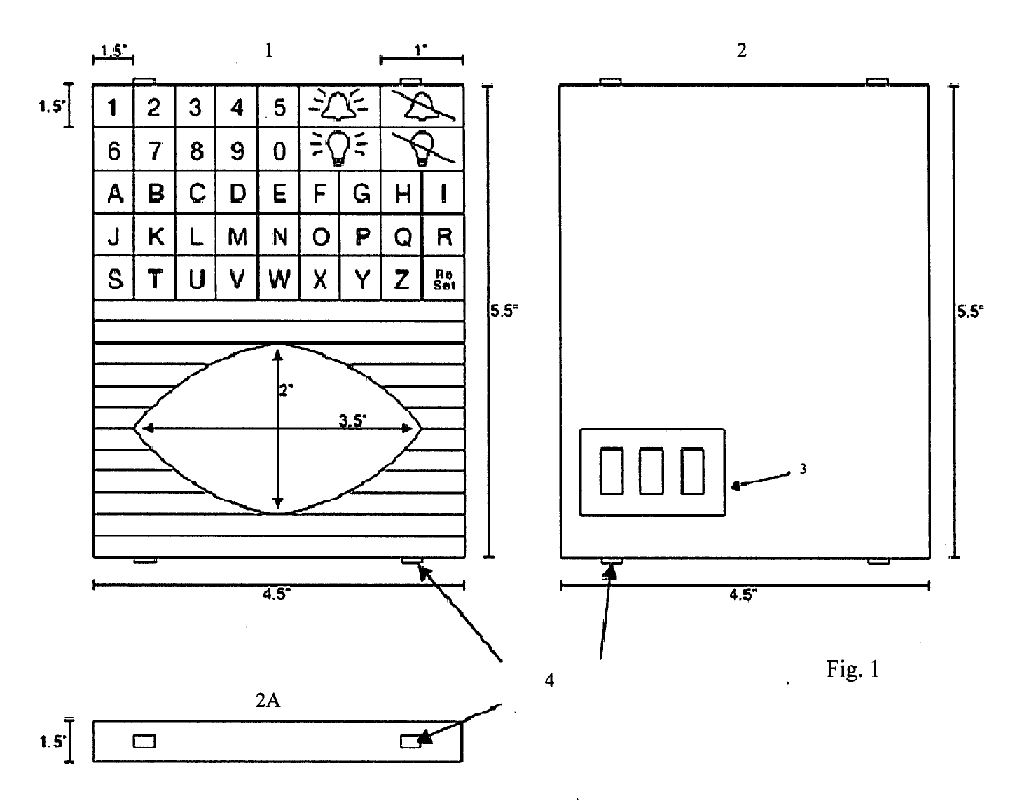

As shown in FIG. 1, front, back and top view of the Debo Alarm System's Keypad. 1, is the front view of the keypad, where you can enter your alarm code and the speaker where the alarm sounds. 2, is the back view of the keypad. 2A, is the top view of the keypad. 3, is the internal rechargeable battery connection, data and information connection is located. 4, is the snap arms to hold the keypad into the Debo Alarm System's base.

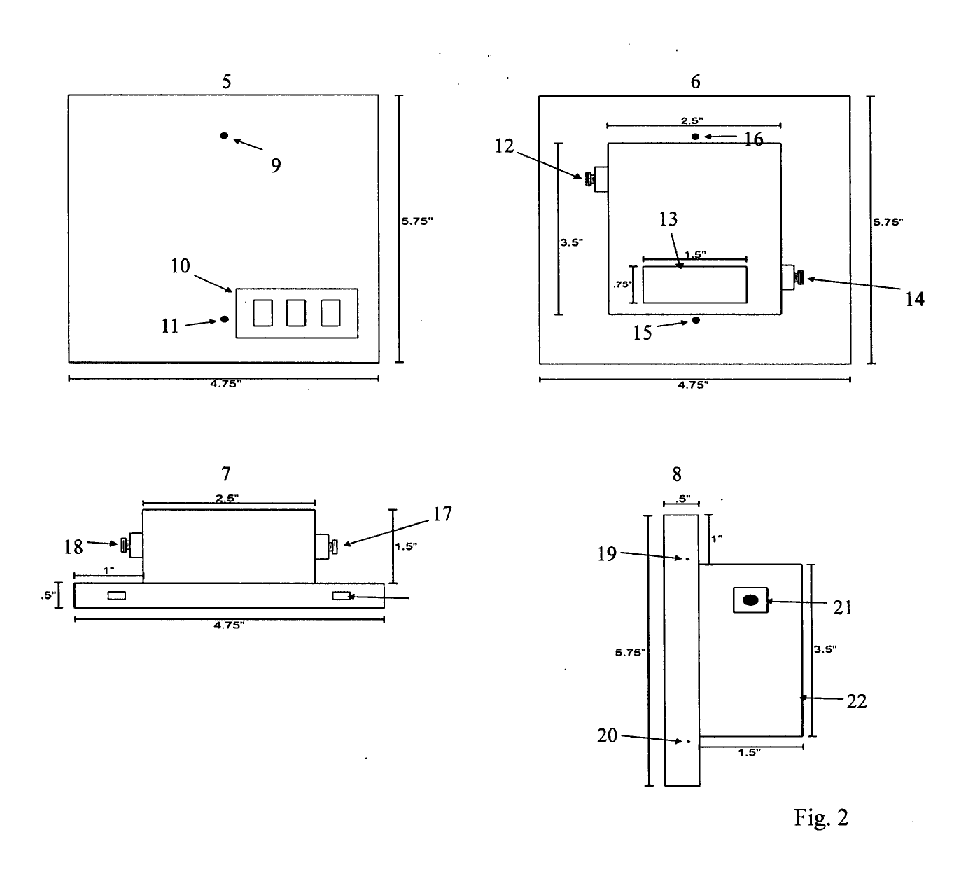

As shown in FIG. 2, front, back, side and top view of the Debo Alarm System's Base. 5, is the front view of the base. 6, is the back view of the base, which is inserted into the light switch location after the switch is removed. 7, is the top view of the base. 8, is the side view of the base. 9, is a screw hole. 10, is the power, data and information connection which helps power the keypad. 11, is a screw hole. 12, is the negative connection to connect the negative wire in the light switch area. 13, is an internal rechargeable battery in case the power in the area you are trying to secure goes out. 14, is the positive connection to connect the positive wire in the light switch area. 15, is a screw hole. 16, is a screw hole. 17, is the negative connection to connect the negative wire in the light switch area. 18, is the positive connection to connect the positive wire in the light switch area. 25, is a slot to snap the keypad into the base. 19, is a screw hole. 20, is a screw hole. 20, is the negative connection to connect the negative wire in the light switch area. 21, is an internal rechargeable battery in case the power in the area you are trying to secure goes out.

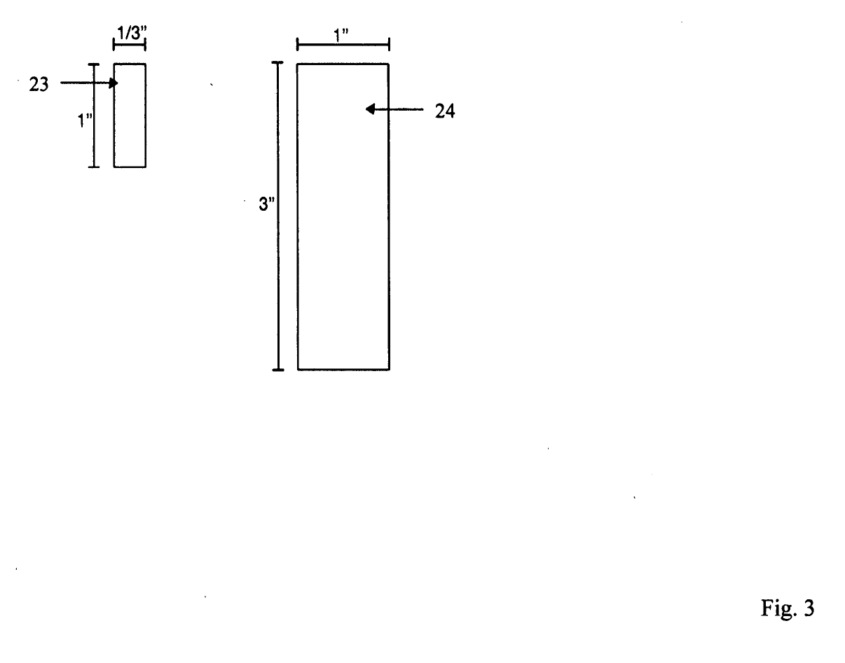

As shown in FIG. 3, Magnet and Receiver which are movable or stationary devices which helps alert the Debo Alarm System when the area you are trying to secure, becomes unsecure. 23, is a magnet which is placed on the doors or windows (movable or stationary device). 24, is a receiver which is placed on the doors or windows (movable or stationary device).

### Instruction on How to Install the Debo Alarm System (D.A.S.)

The Debo Alarm System comes in three parts:
1. The Debo Alarm System Keypad is used to turn the alarm system on and off by entering your alarm code. The keypad also is used to turn the lights on and off. The keypad has an internal rechargeable battery in case the keypad is removed from the base. If the alarm code is not entered, the alarm will sound to alert you that the system is being tampered with.
2. The Debo Alarm System base is placed in the light socket area. Once the central most light switch is removed the security system base will be installed where the light switch was located. The Debo Alarm System base has an internal rechargeable battery in case the power at your home is turned off. The internal rechargeable battery will allow the alarm system to alert you if there is an intruder.
3. The Debo Alarm System monitors are mounted on the designated doors and windows you want to secure. The monitors consist of a magnet and receiver. When the magnet and receiver are separated from one another, the alarm will alert you that the security system is open.

The Debo Alarm System is easy to install.

The D.A.S. base is placed in the wall light socket area.

Locate the central most light socket in your apartment or house.

Turn off the power from the main switch on your breaker box.

Check the designated light switch to see if the power is off. Once the light switch confirms that the power is off, remove the light switch from the wall.

Place the base of the D.A.S. where the light switch was located.

Turn on the power from the main switch on your breaker box.

Place the D.A.S. monitors on the desired doors and windows in your apartment or house.

Place the monitor magnets on the doors or door frames and windows or window frames.

Place the monitor receivers on the doors or door frames and windows or window frames.

Make sure the monitor magnets and receivers are touching. When the door or window is opened and the receiver is moved from the magnet the alarm is triggered.

Place the D.A.S. keypad in the D.A.S. base and the keypad will light up indicating the D.A.S. is ready to be set up for service.

Hold the re-set button until the keypad blinks twice.

The keypad blinks twice it is indicating it is ready for you to enter your alarm code.

The alarm code can be up to 8 characters. For example: (1234safe).

Once your alarm code is entered push the re-set button again to set your alarm code.

Enter your alarm code to turn your alarm system on or off.

Once you are satisfied with your alarm code, test the D.A.S. by opening the designated doors and windows.

The D.A.S. has a 12 sec. delay when you arm your alarm system before you leave your apartment or house.

Before you go to sleep push the on button then enter your alarm code to bypass the 12 sec. delay.

The D.A.S. can be used to turn your light on and off.

If a monitor is not set up correctly the D.A.S. will help you in trouble shooting your alarm system.

Enter in your alarm code before removing the keypad or the alarm will go off. The keypad has an internal rechargeable battery so the alarm will still sound.

Your Debo Alarm System (D.A.S.) is now ready to protect your family, self or property with all the protection and none of the cost of the expensive home alarm systems.

1. Debo Alarm System is a mobile Security System for the Home, Apartment, RV, and Commercial Businesses etc. . . This alarm system is unique because it utilizes the existing wiring in the area you are trying to secure.
The Debo Alarm System comes in three parts:
1. The Debo Alarm System Keypad is used to turn the alarm system on and off by entering your alarm code. The keypad also is used to turn the lights on and off. The keypad has an internal rechargeable battery in case the keypad is removed from the base. If the alarm code is not entered, the alarm will sound to alert you that the system is being tampered with.
2. The Debo Alarm System base is placed in the light socket area. Once the central most light switch is removed the security system base will be installed where the light switch was located. The Debo Alarm System base has an internal rechargeable battery in case the power at your home is turned off. The internal rechargeable battery will allow the alarm system to alert you if there is an intruder.
3. The Debo Alarm System monitors are mounted on the designated doors and windows you want to secure. The monitors consist of a magnet and receiver. When the magnet and receiver are separated from one another
